(19) United States
(12) Patent Application Publication
(10) Pub. No.: US 2007/0017190 A1
(43) Pub. Date: Jan. 25, 2007

(54) Vacuum cleaner having a separator for separating dust by virtue of initial force

(76) Inventors: Ritsuo Takemoto, Hadano-shi (JP); Hiroshi Yokoyama, Odawara-shi (JP); Masatoshi Tanaka, Ebina-shi (JP); Ai Tanaka, Tokyo (JP); Mai Matsuno, Hadano-shi (JP); Yasushi Takai, Ashigarakami-gun (JP); Yoshihiro Tsuchiya, Suntou-gun (JP)

Correspondence Address: HARNESS, DICKEY & PIERCE, P.L.C., P.O. BOX 828, BLOOMFIELD HILLS, MI, 48303, US

(21) Appl. No.: 11/487,958

(22) Filed: Jul. 17, 2006

(30) Foreign Application Priority Data
Jul. 21, 2005 (JP) 2005-211395

(51) Int. Cl. B01D 50/00

(52) U.S. Cl. 55/337

(57) ABSTRACT

A vacuum cleaner includes a separator case, a motor-driven blower, and a separator. The separator has a separating chamber configured to separate, by using an inertial force, dust from air drawn into the separator case. A dust-collecting section collects the dust separated from air by the separator. A filter catches the dust that has passed through the separator. The dust caught by the filter is dropped by a dust-dropping mechanism. The separator case has a dust-discharging port for guiding the dust dropped from the filter into the separating chamber. The vacuum cleaner further has a shield member that can move between a first position and a second position. At the first position, the shield member connects the dust-discharging port to the separating chamber. At the second position, the shield member disconnects the dust-discharging port from the separating chamber.

### CROSS-REFERENCE TO RELATED APPLICATIONS

This application is based upon and claims the benefit of priority from prior Japanese Patent Application No. 2005-211395, filed Jul. 21, 2005, the entire contents of which are incorporated herein by reference.

### BACKGROUND OF THE INVENTION

1. Field of the Invention

This invention relates to a vacuum cleaner in which a separator utilizing an inertial force and a filter positioned downstream of the separator cooperate to separates dust from the air drawn by a motor-driven blower. More particularly, the invention relates to a structure that returns the dust from the filter to into the separator and then sends the dust to a dust-collecting unit.

2. Description of the Related Art

Vacuum cleaners are known, in which an inertial force separates dust from the air drawn by a motor-driven blower, thus making a bag-shaped pack filter unnecessary. A vacuum cleaner of this type is disclosed in, for example, the specification of Japanese Patent No. 3490081.

The vacuum cleaner disclosed in the patent specification has a main unit that contains a motor-driven blower. The main unit supports a dust-collecting container that can be detached. The container has a first dust-collecting chamber, a negative-pressure chamber, a separation unit, and a guide pipe. The negative-pressure chamber is located above the first dust-collecting chamber. The separation unit is provided in the negative-pressure chamber. The guide pipe connects the separation unit and the first dust-collecting chamber.

When the motor-driven blower operates, a negative pressure is generated in the negative-pressure chamber. The negative-pressure chamber communicates with the first dust-collecting chamber via a net-like filter. The separation unit has an air passage that is shaped like a hollow cylinder. The upstream end of the air passage is connected to a hose that draws dust. The downstream end of the air passage is connected to the guide pipe. The air passage communicates with the negative-pressure chamber via a net-like filter.

The air containing dust, drawn from the hose into the air passage of the separation unit, is led into the negative-pressure chamber through the net-like filter. Dust particles of relatively large mass pass through the air passage by virtue of inertial force and move into the first dust chamber through the guide pipe. The dust is therefore separated from air in the separation unit.

The vacuum cleaner disclosed in the above-identified patent specification has a pleat filter provided between the motor-driven blower and the dust-collecting container. The pleat filter is designed to catch fine dust particles that have passed through the separation unit. The filter is positioned more downstream than the separation unit, with respect to the direction in which air flows. The dust-collecting container has the second dust chamber located below the pleat filter. The second dust chamber is partitioned from the first dust chamber by the rear wall of the dust-collecting container. The rear wall lies near the front of the pleat filter. A gap is provided between the rear wall and the front of the pleat filter, extending in the lengthwise direction of the dust-collecting container. The gap opens at the upper end to the negative-pressure chamber, and at the lower end to the second dust chamber.

The dust caught at the pleat filter is removed from the pleat filter by a dust-dropping mechanism. The dust-dropping mechanism vibrates the pleat filter, dropping the fine dust particles from the pleat filter. The dust particles dropped from the pleat filter are guided into the second dust chamber through the small gap between the rear wall and the pleat filter.

In the vacuum cleaner described above, the first dust chamber collects the dust separated from air by the separation unit, and the second dust chamber collects the dust dropped from the pleat filter. The dust separated from air are therefore distributed into two dust chambers and cannot be collected in only the first dust chamber, i.e., the main dust chamber. Consequently, it is troublesome for the user to discard the dust from the dust-collecting container.

In the conventional vacuum cleaner, the negative-pressure chamber from which the motor-driven blower draws air communicates, through the gap, with the second dust chamber that collects dust from the pleat filter communicate. The gap is indeed narrow, but the second dust chamber is influenced, to some extent, by the air that flows in the negative-pressure chamber every time the motor-driven blower starts operating.

The dust collected by the second dust chamber is inevitably drawn through the gap and may stick to the pleat filter again. If dust sticks to the pleat filter, the resistance to the air passing through the pleat filter may increase. This may lower the dust-attracting performance of the vacuum cleaner.

Further, the pleat filter clogs even after a short use. The pleat filter should therefore be cleaned frequently. The maintenance of the vacuum cleaner requires much time and labor.

### BRIEF SUMMARY OF THE INVENTION

An object of this invention is to provide a vacuum cleaner in which dust can be efficiently accumulated in a dust-collecting section and prevented from sticking to a filter again and the dust-attracting performance remains high for a long time.

To achieve the object, a vacuum cleaner according to the present invention comprises: a separator case which has a dust-discharging port; a motor-driven blower which generates a negative pressure in the separator case; a separator which is provided in the separator case and has a separating chamber communicating with the dust-discharging port and configured to separate dust from air drawn into the separator case, by using an inertial force; a dust-collecting section which collects the dust separated by the separator; a filter which catches the dust passed through the separator; a dust-dropping mechanism which drops the dust caught by the filter; and a shield member which is configured to move between a first position and a second position. At the first position, the shield member connects the dust-discharging port to the separating chamber. At the second position, the shield member disconnects the dust-discharging port from the separating chamber. The shield member remains at the second position as long as the motor-driven blower operates. The shield member moves to the first position to allow the dust dropped by the dust-dropping mechanism to move into the separating chamber through the dust-discharging port.

In the vacuum cleaner according to the present invention, the dust dropped from the filter can be moved into the separating chamber and then collected in the dust-collecting section. This helps to enhance the efficiency of accumulating the dust in the dust-collecting section. In addition, the dust dropped from the filter can be prevented from sticking to the filter again. Therefore, the vacuum cleaner can long maintain its high dust-attracting performance.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing a vacuum cleaner according to an embodiment of the present invention;

FIG. 2 is a perspective view of a dust separator incorporated in a main unit of the vacuum cleaner, as viewed from an air-inlet port;

FIG. 3 is a perspective view of the dust separator, as viewed from an air-outlet port;

FIG. 4 is a partly sectional, perspective view showing a part of the dust separator;

FIG. 5 is a sectional view taken along line F5-F5 line shown in FIG. 3;

FIG. 6 is a perspective view of a first case constituting the dust separator, as viewed from the air-outlet port;

FIG. 7 is a rear view of the first case, as from the air-outlet port;

FIG. 8 is a perspective view of a pleat filter used in the embodiment of the invention; and

FIG. 9 is a sectional view schematically illustrating the positional relation between the pleat filter and a dust-removing projection in the embodiment of the invention.

### DETAILED DESCRIPTION OF THE INVENTION

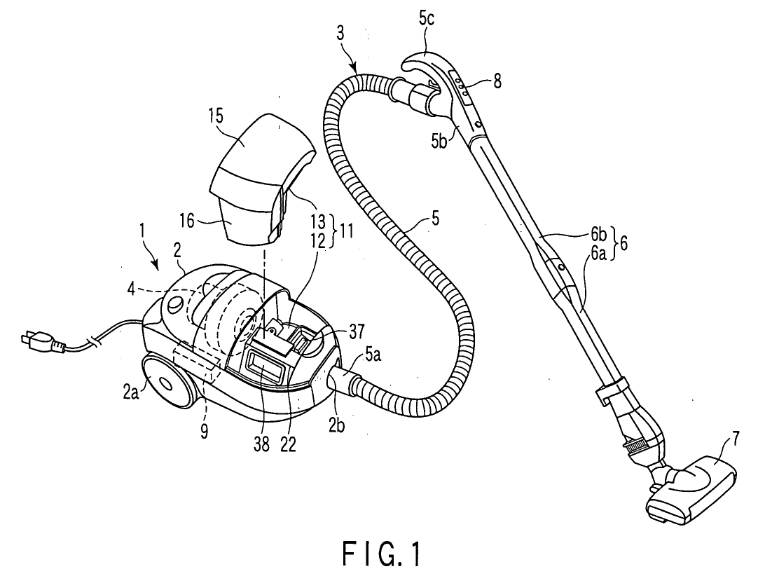

An embodiment of this invention will be described, with reference to FIGS. 1 to 9.

FIG. 1 shows a vacuum cleaner 1 that can move on, for example, the floor that should be cleaned. The vacuum cleaner 1 has a main unit 2 and a suction unit 3. The man unit 2 has wheels 2a and a connection mouth 2b. The wheels 2a touch the floor. The connection mouth 2b opens in the front of the main unit 2. The main unit 2 incorporates a motor-driven blower 4, in its rear half. The blower 4 has an air-inlet port 4, which opens to the front of the main unit 2.

The suction unit 3 has a suction hose 5, an extension pipe 6, and a suction head 7. The suction hose 5 has a cylindrical connection part 5a at one end and a control unit 5b on the other end. The connection part 5a is removably inserted in the connection mouth 2b. The control unit 5b has a handle 5c and an operation panel 8. The operation panel 8 has buttons, which may be pushed to operate a control unit 9 incorporated in the main unit 2. The control unit 9 includes a printed circuit board, on which various circuit components are mounted. The control unit 9 controls the motor-driven blower 4 in accordance with instructions supplied from, for example, the operation panel 8.

The extension pipe 6 comprises, for example, an upstream pipe 6a and a downstream pipe 6b. The upstream pipe 6a and the downstream pipe 6b are connected together and can be disconnected from each other. The downstream pipe 6b is removably attached to the control unit 5b. The suction head 7 is removably attached to the upstream pipe 6a.

The main unit 2 holds a dust separator 11. The dust separator 11 is provided between the air-inlet port 4a of the motor-driven blower 4 and the connection mouth 2b of the main unit 2. As shown in FIGS. 1 to 3, the dust separator 11 has a main body 12 and a dust-collecting case 13.

The dust-collecting case 13 is an example of a dust-collecting section that collects the dust the vacuum cleaner 1 has drawn. The dust-collecting case 13 is removably attached to the main body 12 from above at the front of the main unit 2. Hence, the dust accumulated in the case 13 can be discarded easily.

The dust-collecting case 13 has a handle 14 on the upper surface. The user may grasp the handle 14 to remove the dust-collecting case 13 from the main body 12 or to set the dust-collecting case 13 in the main body 12.

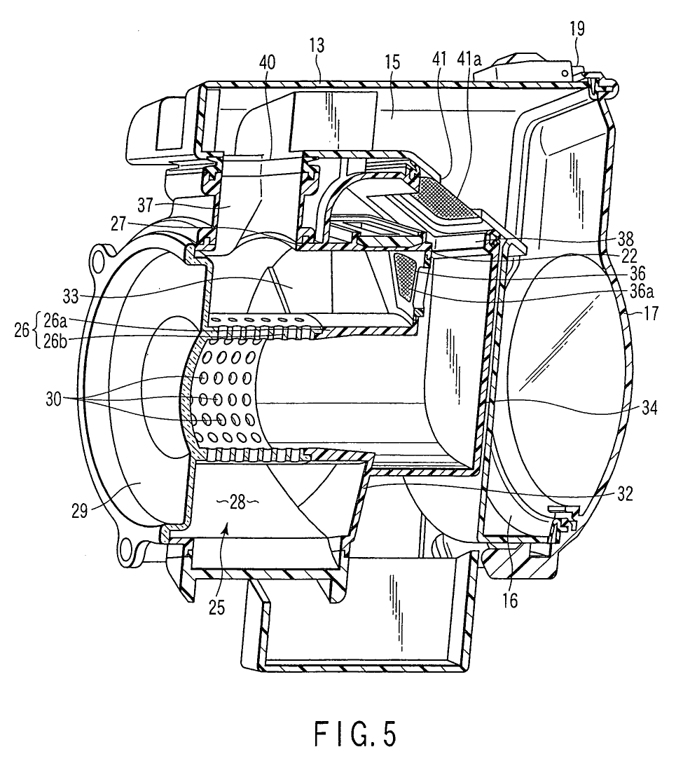

As shown in FIG. 5, the dust-collecting case 13 has a dust passage 15, a dust recovery chamber 16, and a cover 17. The dust passage 15 extends in the widthwise direction of the main unit 2. The dust recovery chamber 16 extends downward from the downstream end of the dust passage 15. The cover 17 covers the dust recovery chamber 16 from one side. The cover 17 is fastened, at lower edge, to a hinge 18. It can rotate around the hinge 18 between an opened position and a closed position. At the opened position, the cover 17 falls to one side of dust-collecting case 13 so that the dust accumulated in the dust recovery chamber 16 can be thrown away. At the closed position, the cover 17 stands, extending along the dust recovery chamber 16 and closing the dust recovery chamber 16.

A holding member 19 holds the cover 17 in the closed position. The holding member 19 can be manually moved between a locked position and an unlocked position. At the locked position, the holding member 19 holds the upper edge of the cover 17. At the unlocked position, the holding member 19 no longer holds the upper edge of the cover 17.

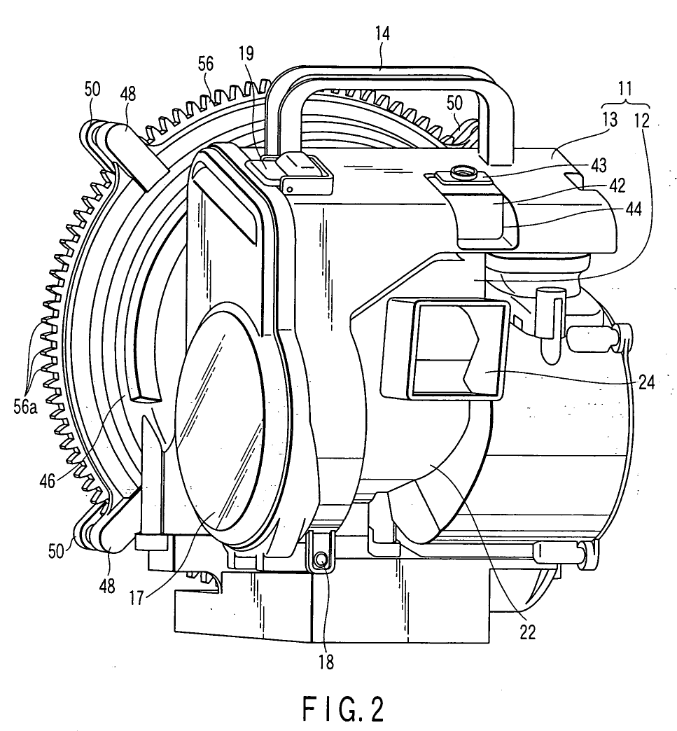

As shown in FIGS. 2 to 4, the main body 12 has a separator case 21 that is made of a synthetic resin. The separator case 21 is composed of a first case member 22 and second case member 23. The case members 22 and 23 are coupled to each other. The first case member 22 has an air-inlet port 24 that projects forwards. The air-inlet port 24 is connected to the connection mouth 2b of the main unit 2.

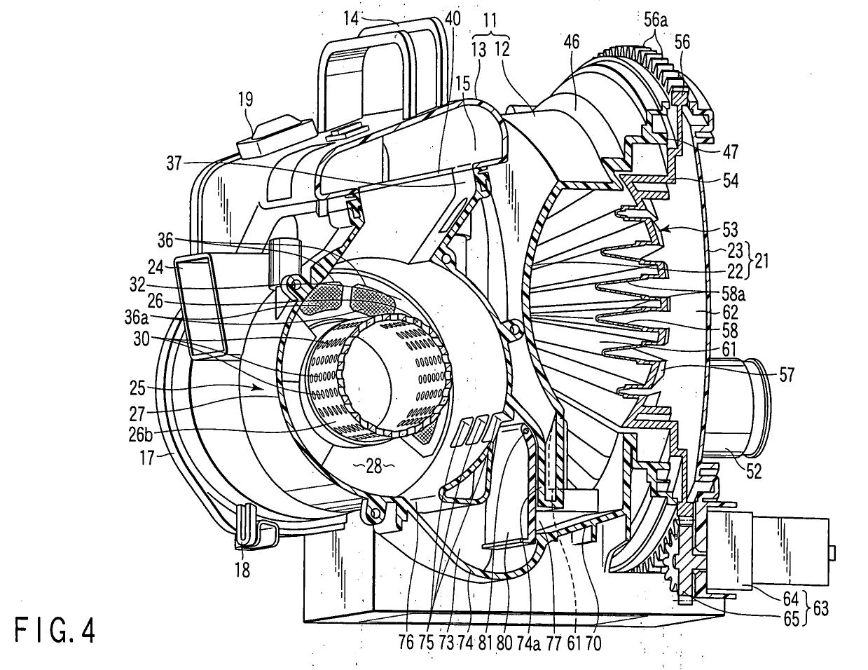

As shown in FIGS. 4 and 5, the first case member 22 contains a separator 25. The separator 25 uses an inertial force to separate dust from air in the separator case 21. The separator 25 has air-intake cylinder 26, a guide wall 27, and a separating chamber 28.

The air-intake cylinder 26 has a first cylinder part 26a and a second cylinder part 26b. The first cylinder part 26a is provided in the first case member 22. The second cylinder part 26b is connected to the distal end of the first cylinder part 26a and axially aligned with the first cylinder part 26a. The second cylinder part 26b is integrally formed with a cover member 29. The cover member 29 closes one end of the air-intake cylinder 26 and covers the open end of the first case member 22.

The guide wall 27 is a hollow cylinder that surrounds the air-intake cylinder 26 and positioned coaxial with the air-intake cylinder 26. The guide wall 27 is arranged in the first case member 22. The separating chamber 28 is provided between the air-intake cylinder 26 and the guide wall 27. The second cylinder part 26b of the air-intake cylinder 26 defining the separating chamber 28 has a plurality of small through holes 30 that open to the separating chamber 28. In this embodiment, the cover member 29 closes one end of separating chamber 28 and is made of transparent material so that the interior of the separating chamber 28 may be seen from outside the separator case 21.

The first case member 22 has a first edge wall 32. The first edge wall 32 faces the cover member 29 and closes the other end of separating chamber 28. As best shown in FIG. 5, the first edge wall 32 is a spiral wall that approaches the cover member 29. It has a first end that lies near the cover member 29, a second end that is remote from the cover member 29, and an intermediate part that lies between the first end and second end. An inlet port 33 is formed in the intermediate part of the first edge wall 32. The Inlet port 33 communicates with the air-inlet port 24.

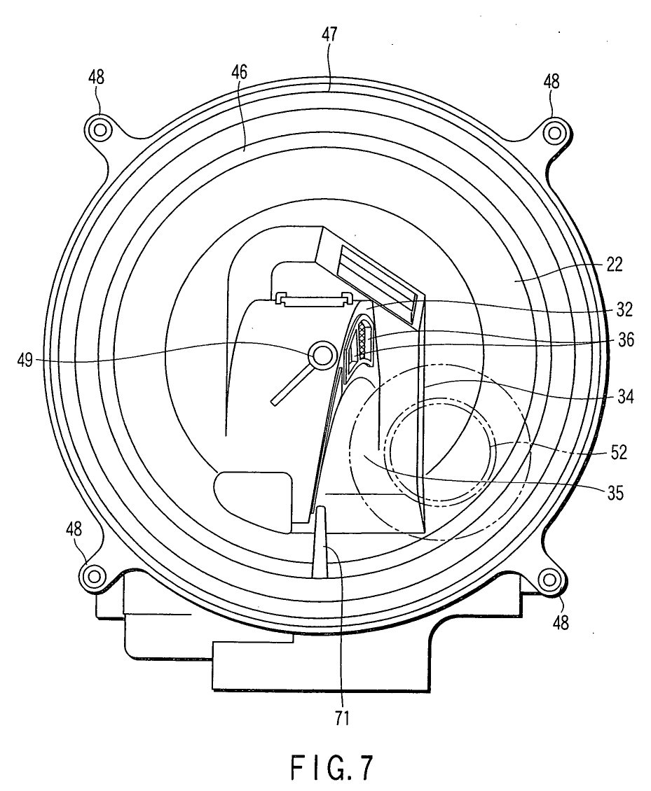

As shown in FIGS. 5 and 7, the first case member 22 has a second edge wall 34. The second edge wall 34 is located at the other end of air-intake cylinder 26 and adjoins the first edge wall 32. The second edge wall 34 has an air passage 35. The air passage 35 communicates with the interior of the air-intake cylinder 26 and opens to the back of the first case member 22.

The second end of the first edge wall 32 has a plurality of vents 36. The vents 36 connect the separating chamber 28 to the air passage 35. The vents 36 are covered with net-like filters 36a.

As shown in FIGS. 4 to 6, the upper part of the first case member 22 has an outlet port 37 and a vent 38. The outlet port 37 projects upward from the first case member 22. The vent 38 opens in the upper surface of the first case member 22, adjoins the outlet port 37, and communicates with the air passage 35.

As FIG. 5 shows, the dust-collecting case 13 is removably secured to the first case member 22, covering the outlet port 37 and vent 38 from above. The dust-collecting case 13 has an entrance 40 and an exhaust port 41. The entrance 40, which opens to the dust passage 15, is connected to the outlet port 37 of the first case member 22. The exhaust port 41 is connected to the vent 38 of the first case member 22 and is covered with a net-like filter 41a.

As FIGS. 2 and 4 show, the first case member 22 has a positioning part 42. The positioning part 42 protrudes upward, from the upper surface of the first case member 22. A lock member 43 is secured to the top of the positioning part 42 and can rotate.

The dust-collecting case 13 extends over the first case member 22. It has a groove 44, in which the positioning part 42 is fitted. Once the positioning part 42 is fitted in the groove 44, the first case member 22 and the dust-collecting case 13 assumes a specific positional relation. The lock member 43 attached to positioning part 42 can rotate between a locked position and an unlocked position when manually operated. At the locked position, the lock member 43 is caught on the upper surface of dust-collecting case 13, whereby the dust-collecting case 13 holds the first case member 22. At the unlocked position, the lock member 43 is spaced from the upper surface of the dust-collecting case 13, making it possible to remove the dust-collecting case 13 from the first case member 22.

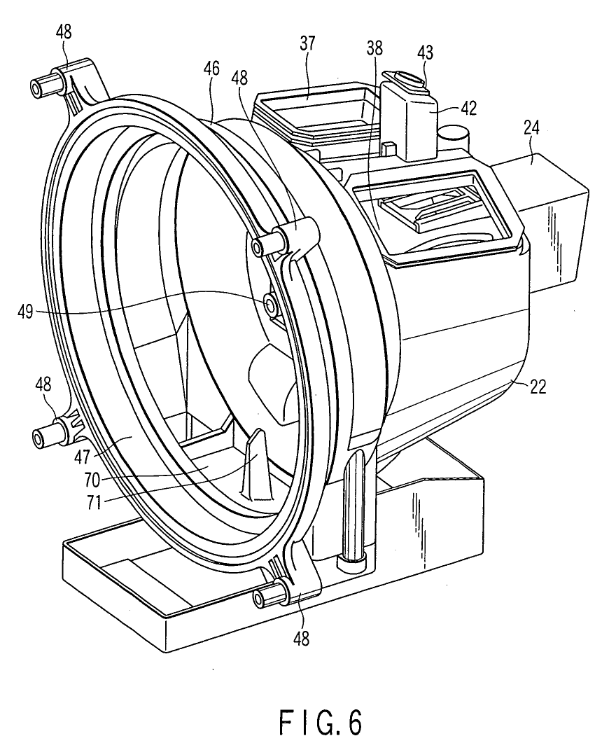

As is best shown in FIGS. 6 and 7, the first case member 22 has a rear part 46 at the back of the dust-collecting case 13. The rear part 46 is shaped like a hollow cylinder and flares toward the back of the dust-collecting case 13. A cylindrical guide wall 47 is provided at the rear part 46 of the dust-collecting case 13. The guide wall 47 has a larger diameter than the rear part 46 and is position coaxial with the rear part 46. The guide wall 47 is located at the rear end of the first case member 22. Connecting projections 48 protrude from the circumferential surface of guide wall 47 in radial direction thereof.

As best shown in FIGS. 6 and 7, a hollow shaft 9 is formed integrally with the first case member 22. The shaft 49 projects toward the back of the first case member 22 and lies coaxial with the guide wall 47.

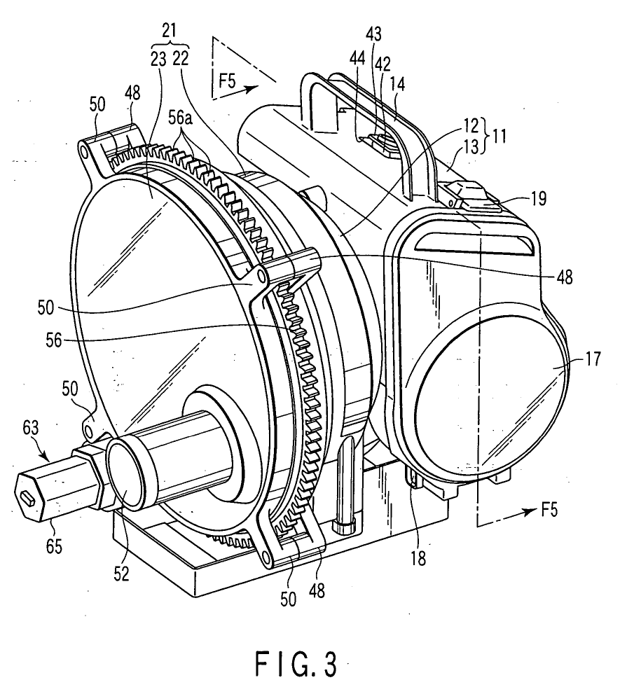

As FIGS. 3 and 4 show, the second case member 23 is shaped like a disc. It covers the rear end of the first case member 22 from behind. The second case member 23 has a diameter similar to that of the guide wall 47 of the first case member 22. Connecting projections 50 protrude from the outer circumferential surface of the second case member 23. Each connecting projection 50 extends in the radial direction of the second case member 23.

The connecting projections 50 of the second case member 23 are removably fitted in the connecting projections 48 of the first case member 22, respectively. The first case member 22 and the second case member 23 are therefore coupled to each other. The first guide wall 47 of the first case member 22 is spaced from, and opposed to, the second case member 23. Hence, the connecting projections 48 and 50 serve as spacers, spacing the guide wall 47 from the second case member 23.

As shown in FIG. 3, the second case member 23 has an air-outlet port 52 that projects backward. The air-outlet port 52 is eccentric to the second case member 23. It is therefore displaced downward and slantwise with respect to the air passage 35, as is illustrated in FIG. 7. The air-outlet port 52 communicates with the air-inlet port 4a of the motor-driven blower 4.

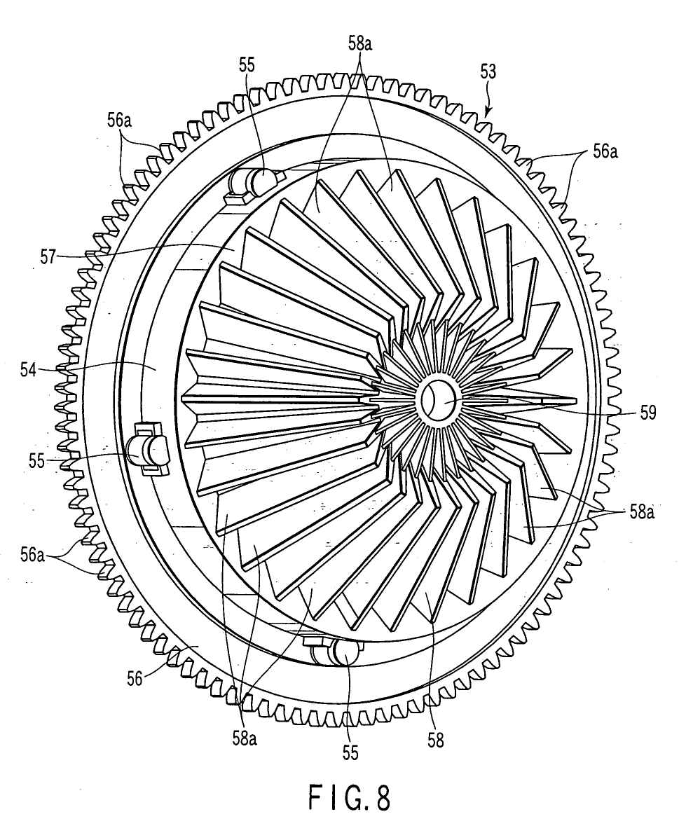

As FIG. 4 shows, a filter 53 is provided inside the guide wall 47 of the first case member 22. FIG. 8 depicts the configuration the filter 53 may have. The filter 53 shown in FIG. 8 has a roller-supporting wall 54, rollers 55, a driven gear 56, a filter frame 57, and a filter element 58.

The roller-supporting wall 54 is a hollow cylinder having a smaller diameter than the guide wall 47. The rollers 55 are rotatably supported on the circumferential surface of the roller-supporting wall 54. They are arranged in the circumferential direction of the roller-supporting wall 54 and are spaced from one another. The driven gear 56 is integrally formed with the roller-supporting wall 54 and positioned at the rear edge of the roller-supporting wall 54. Its teeth 56a protrude from the roller-supporting wall 54. In other words, the driven gear 56 has a larger diameter than the roller-supporting wall 54.

The filter frame 57 is integrally formed with the front edge of the guide wall 47. The filter frame 57 is located inside the guide wall 47. The filter element 58 is secured to the filter frame 57. The filter element 58 has pleats 58a, which are fastened to the filter frame 57. The filter frame 57 and the filter element 58 constitute a so-called pleat filter. The pleat filter is shaped like a cone in the present embodiment. Its diameter gradually decreases toward the first case member 22. The front end of filter frame 57 lies at the center part of the front of the filter 53. The filter frame 57 has a bearing hole 59 in the center part of the front end.

To accommodate the filter 53 inside the guide wall 47, the shaft 49 projecting from the first case member 22 is guided through the bearing hole 59 of the filter frame 57, and rollers 55 are set in contact with the inner skin of guide wall 47. The filter 53 is thereby incorporated into the first case member 22 free and can rotate around the shaft 49.

As long as the filter 53 remains incorporated in the first case member 22, the pleats 58a of the filter element 58 incline to the axis of rotation of the filter 53. The driven gear 56 of the filter 53 protrudes from the separator case 21, through a gap between guide wall 47 of the first case member 22 and the second case member 23.

Two sealing members (not shown), each shaped like a ring, are interposed, respectively between the filter 53 and the guide wall 47 of the first case member 22 and between the filter 53 and the second case member 23. The sealing members maintain an airtight connection between the separator case 21 and the filter 53.

The filter 53 is located between the separator 25 and the motor-driven blower 4. As shown in FIG. 4, an upstream chamber 61 lies between the filter 53 and the rear part 46 of the first case member 22 as long as the filter 53 remains in the rear of separator case 21. Similarly, a downstream chamber 62 lies provided between the filter 53 and the second case member 23.

The air passage 35 of the first case member 22 is exposed to the upstream chamber 61 and opposed to the front of the pleat filter. The air-outlet port 52 of the second case member 23 is exposed to the downstream chamber 62 and opposed to the rear surface of the pleat filter. Therefore, air will be drawn from the within separator case 21 via the air-inlet port 4a, generating a negative pressure in the separator case 21 when the motor-driven blower 4 starts operating in response to an instruction given the control unit 9.

As shown in FIG. 4, a filter driver 63 is secured to the second case member 23. The filter driver 63 has an electric motor 64 and a drive gear 65. The electric motor 64 rotates the drive gear 65. It is desired that the electric motor 64 be a stepping motor that can control the rotation angle. The drive gear 65 meshes with driven gear 56 of the filter 53. Thus, the torque of the electric motor 64 is transmitted to the to the filter 53, which rotates against the frictional resistance of the sealing members.

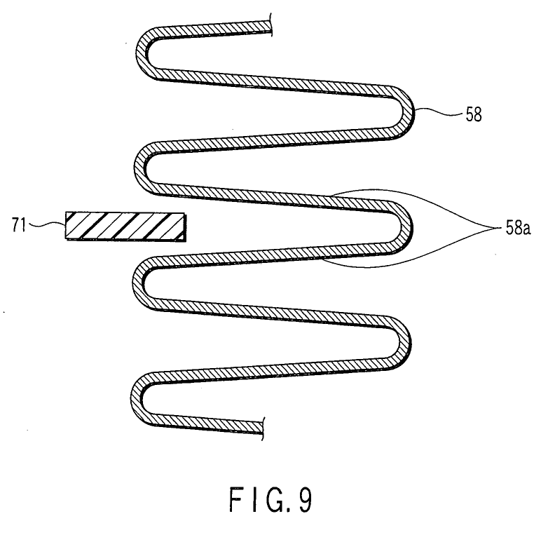

As shown in FIGS. 4 and 6, the rear part 46 of the first case member 22 has a bottom wall 70. The bottom wall 70 lies before the guide wall 47 and below the filter element 58. A projection 71 for scraping dust is formed in the upper surface of the bottom wall 70. The projection 71 is an example of the dust-dropping mechanism that drops dust from the pleat filter. It protrudes upward from the upper surface of the bottom wall 70. It is a long and slender plate that can elastically deform in the widthwise direction of the first case member 22 and is located in the upstream chamber 61. As FIG. 9 shows, the projection 71 extends into the gap between two of the pleats 58a, at the lower part of the filter element 58. In other words, the projection 71 lies between the adjacent pleats 58a and intersects the rotation locus of the circumferential part of the filter element 58.

Therefore, when filter 53 receives torque from the electric motor 64 and rotates, the pleats 58a of filter element 58 sequentially move over the projection 71. The projection 17 flips and vibrates the pleats 58. As a result, dust, if any on the filter element 58, falls from the filter element 58.

The dust is dropped from the dropping filter 53 as the control unit 9 controls the motor-driven blower 4. More precisely, the control unit 9 gives an operation instruction to the filter driver 63 if the blower 4 does not operate even after a predetermined time has elapsed from the moment the blower 4 was stopped by an instruction from the operation panel 8. Alternatively, the control unit 9 gives the operation instruction to the filter driver 63 if the motor-driven blower 4 has been stopped, terminating cleaning. In either case, the vacuum cleaner 1 is set to automatic dust-dropping mode, in which the filter 53 rotates through, for example, 360° or more.

As shown in FIG. 4, the separating chamber 28 of the separator 25 has a dust-recovering section 73. The dust-recovering section 73 is defined by an extension wall 74 that protrudes downward from the lower part of the guide wall 27. The rear end of the extension wall 74 is continuous to the rear part 46 and bottom wall 70 of the case member 22. The bottom of the dust-recovering section 73 curves like an arc, extending below the bottom wall 70.

The dust-recovering section 73 has inlet ports 75 and an outlet port 76. The inlet ports 75 lie behind the air-intake cylinder 26 and open to the separating chamber 28. The outlet port 76 lie below the air-intake cylinder 26 and open to the separating chamber 28. The outlet port 76 is located downstream of the inlet ports 75, in the direction that the air flows in the separating chamber 28.

In other words, the dust-recovering section 73 has two ends, one branching from the separating chamber 28, and the other connected to the separating chamber 28.

Thus, a part of air current which flows through separating chamber 28 flows into the dust-recovering section 73 through the inlet ports 75 and is returned to the separating chamber 28 through the outlet port 76. Therefore, the part of air current, which has flown into the separating chamber 28, passes through dust-recovering section 73.

As FIG. 4 shows, the extension wall 74 of the dust-recovering section 73 has a partition part 74a that lies above the bottom wall 70. The partition part 74a is interposed between the dust-recovering section 73 and the lower part of upstream chamber 61. The partition part 74a has a dust-discharging port 77. The dust-discharging port 77 lies at the same level as the bottom wall 70. The dust-discharging port 77 connects the lower part of the upstream chamber 61 to the dust-recovering section 73. In this embodiment, the bottom wall 70 inclines down, toward the dust-discharging port 77.

As shown in FIG. 4, a shield member 80 is provided in the dust-recovering section 73. The shield member 80 is a thin plate made of synthetic resin. It is arranged, extending along the partition part 74a of the extension wall 74. The upper end of the shield member 80 is supported by pivot shaft 81 and secured to the first case member 22.

The shield member 80 can rotates between a first position and a second position. At the first position, the shield member 80 opens the dust-discharging port 77. At second position, it closes the dust-discharging port 77. When the shield member 80 opens the dust-discharging port 77, the lower part of the upstream chamber 61 and the dust-recovering section 73 communicate with each other. When shield member 80 closes the dust-discharging port 77, the lower part of upstream chamber 61 and the dust-recovering section 73 no longer communicate with each other. FIG. 4 depicts the shield member 80 rotated to the second position.

In this embodiment, the shield member 80 is normally held at first position by a spring (not shown). The shield member 80 is attracted to the dust-discharging port 77 when a negative pressure is generated in the upstream chamber 61 of the separator case 21 as the motor-driven blower 4 operates. The shield member 80 then rotates from the first position to the second position, against the force of the spring. It therefore closes the dust-discharging port 77 as illustrated in FIG. 4.

How the vacuum cleaner 1 operates will be explained.

The motor-driven blower 4 starts operation when the user operates the operation panel 8. Air is drawn from separator case 21 via the filter 53. A negative pressure is generated in the separating chamber 28 of separator 25. As a result, dust, if any on the floor, is drawn together with air, from the suction head 7 into the connection mouth 2b of the main unit 2 via the suction unit 3.

The air containing the dust is applied to the filter 53 undergoes dust-air separation using an inertial force in the separator 25 as it passes through the dust separator 11. The air then undergoes filtration as it passes the filter 53. The dust is therefore separated from the air. The air now clean, not containing dust, flows from the separator case 21 through the air-outlet port 52 and then discharged from the main unit 2 by the motor-driven blower 4.

The separator 25 separates dust from air as follows. The air containing dust flows from air-inlet port 24 into the separating chamber 28 through the inlet port 33. In the separating chamber 28, the air flows along the first spiral edge wall 32, making a swirl. A centrifugal force therefore acts on the dust contained in the air. Large dust particles, each having a large mass, are attracted to the guide wall 27 and move along the inner surface of the guide wall 27 toward the outlet port 37. The large-mass dust particles then move from the outlet port 37 via the case entrance 40 into the dust passage 15 of the dust-collecting case 13.

On the other hand, the small dust particles and a part of air are drawn from the separating chamber 28 into the air-intake cylinder 26 via the through holes 30. The large-mass dust particles are separated from the air in the separator 25.

A part of air swirls in the separating chamber 28 flows into the dust-recovering section 73 through the inlet port 75. From the dust-recovering section 73, the air flows through the outlet port 76, back into the separating chamber 28. In the separating chamber 28, the air flows together with the air current that has been flowing in the separating chamber 28.

The air drawn into the air-intake cylinder 26 flows into the air passage 35. Meanwhile, a part of the air flowing in the separating chamber 28 flows into the air passage 35 through the filters 36a provided in the vent 36 and joins the air flowing from the air-intake cylinder 26. The air flown into the dust passage 15 of the dust-collecting case 13, together with the large-mass dust particles, is drawn into the air passage 35 via the filter 41a provided in the exhaust port 41 and the vent 38. The air then joins the air flowing from the above-mentioned air-intake cylinder 26.

As a result, the large-mass dust particles guided into the dust passage 15 of dust-collecting case 13 move toward the dust recovery chamber 16, by virtue of the airflow. The moving of the dust particles is promoted in the dust passage 15. These dust particles are fast guided into the dust recovery chamber 16.

The air flows from the air passage 35 toward the filter 53. This air containing small dust particles undergoes filtration at the filter element 58. The filter element 58 catches the small dust particles. The clean air, containing no dust flows from the separator case 21 through the air-outlet port 52 and drawn into the motor-driven blower 4.

As long as motor-driven blower 4 keeps operating, a high negative pressure develops in the upstream chamber 61 provided between the filter 53 and the first case member 22. The negative pressure acts in the dust-discharging port 77. Thus, the shield member 80 is attracted, against the force of the spring, toward the dust-discharging port 77, and is finally held at the first position. At the first position, the shield member 80 closes the dust-discharging port 77. The swirling air in the separating chamber 28 would not be drawn into the upstream chamber 61. The separator 25 can therefore separate dust from air at high efficiency.

When the operating mode of the vacuum cleaner 1 changes to the automatic dust-dropping mode, the control unit 9 gives an instruction to the filter driver 63. Upon receiving this instruction, the filter driver 63 generates a prescribed number of drive pulses. The drive pulses drive the electric motor 64. The torque of the motor 64 is transmitted via the drive gear 65 and driven gear 56 to the filter 53. The filter 53 is rotated through the angle prescribed to it.

As the filter element 58 rotates, the circumferential parts of the pleats 58a of filter element 58 move, one after another, over the projection 71. In other words, each pleat 58a is flipped by the projection 71 as it passes by the projection 71. The small dust particles caught mainly at the front of the filter element 58 fall onto the bottom wall 70. The small dust particles caught by the filter element 58 are coagulated, forming large dust particles. The large dust particles fall from the filter 53 onto the bottom wall 70.

The projection 71 vibrates the lower part of the filter element 58 as it flips pleats 58a. The dust comes off the front of filter element 58 and fall immediately. The dust hardly accumulates at the front of the filter element 58.

In the dust-dropping mode, the projection 71 is repeatedly deformed elastically as it flips the pleats 58a of the filter element 58 over again. The vibration accompanying the elastic deformation of the projection 71 is readily transmitted to the bottom wall 70 of the first case member 22. Further, the bottom wall 70 gradually inclines downward as it approaches the dust-discharging port 77. Therefore, the dust dropped onto the bottom wall 70 and coagulated promptly moves from filter element 58 towards dust-discharging port 77, along the bottom wall 70 thus inclined.

In the automatic dust-dropping mode, the motor-driven blower 4 remains stopped. The shield member 80 has therefore moved to the first position. Hence, the dust-discharging port 77 is opened. The dust is fed from the bottom wall 70 into the dust-discharging section 73 through the dust-discharging port 77.

When the cleaning with vacuum cleaner 1 is operated again to continue the cleaning or start cleaning anew, a negative pressure acts in the dust-discharging port 77 as the motor-driven blower 4 is driven. The shield member 80 therefore moves from the first position to the second position and closes the dust-discharging port 77. At the same time, a part of air swirling in the separating chamber 28 passes through the dust-recovering section 73. The dust moved into the dust-recovering section 73 from the dust-discharging port 77 is returned into the separating chamber 28, thanks to the airflow in the dust-recovering section 73.

The dust particles returned into the separating chamber 28 adhere to the large-mass, large dust particles moving along the inner surface of the guide wall 27. They are thus guided from the outlet port 37 to the dust passage 15 of the dust-collecting case 13 through the case entrance 40. That is, the dust dropped from the filter element 58 is collected in the dust recovery chamber 16, together with large dust particles.

In the vacuum cleaner 1 configured as described above, the dust separator 11 can recover the dust separated from the air and the dust dropped from the filter element 58 into the dust recovery chamber 16 of the dust-collecting case 13. Hence, the efficiency of collecting dust in the dust-collecting case 13 can be enhanced.

Since no dust-collecting unit needs to be used to collects the dust dropped from the filter element 58, the dust separator 11 can be more compact than otherwise. Further, since the bottom wall 70 for catching the dust dropped from the filter element 58 inclines downward to the dust-discharging port 77, it receives the vibration generated as the dust falls. Therefore, the dust dropped from the filter element 58 will not stay or accumulate on the bottom wall 70.

In addition, the dust dropped from the filter element 58 would not accumulate in the upstream chamber 61. This is because it is supplied into the dust-recovering section 73 via the dust-discharging port 77. Moreover, the dust is prevented from moving back into the upstream chamber 61 from the dust-recovering section 73, because the shield member 80 automatically closes the dust-discharging port 77 whenever the motor-driven blower 4 starts operating.

Therefore, when motor-driven blower 4 starts operation, the dust automatically dropped from filter element 58 is prevented being drawn, due to a negative pressure, into the upstream chamber 61 and from sticking to the filter element 58 again. The resistance to the airflow passing through the filter element 58 can therefore be reduced, whereby the efficiency of attracting the dust can remain high. Further, the filter element 58 is prevented from clogging, and a maintenance work need not be performed on the filter 53 so frequently. The handling of the filter 53 is therefore easy.

With the vacuum cleaner 1 of this embodiment, the dust dropped from the filter element 58 onto the bottom wall 70 is moved to the dust-recovering section 73, by utilizing the vibration applied to the filter 53 to drop the dust. Hence, no means for moving the dust from the bottom wall 70 to the dust-recovering section 73 is necessary. The dust can be moved, without particular labor.

The configuration and operation of the vacuum cleaner 1 are therefore simple.

In the vacuum cleaner 1 of this embodiment, the negative pressure generated when the motor-driven blower 4 starts operating holds the shield member 80 at the second position. No special members are required to hold the shield member 80 in the second position. This helps to simplify the vacuum cleaner 1, too.

In the vacuum cleaner 1 of this embodiment, the dust-recovering section 73 is secured to the lower part of the separator 25 and communicates with the dust-discharging port 77. Thus, the guide wall 27 of the separator 25 can be positioned at a level appropriate to the filter 53, notwithstanding the position of dust-discharging port 77, though the dust-discharging port 77 opens to a low part of the first case member 22. In other words, the vacuum cleaner 1 has high freedom of design.

This invention is not limited to the above-mentioned embodiment. Various changes and modifications can be made without departing from the scope and spirit of the invention.

For example, the dust-recovering section of the separating chamber may be dispensed with. In this case, the dust-discharging port is made in the guide wall of the separator.

The shield member 80 may not open and close the dust-discharging port 88. It may instead open and close the outlet port 76.

Further, a vibrator may be used as dust-dropping mechanism. In addition to this, a member may be provided, which vibrates the filter, automatically operating as the power cord is pulled out of, and rewound into, the main unit of the cleaner.

The projection used as dust-dropping mechanism may be provided in the second case member, projecting towards the filter as described above. In this case, the projection flips at the inner circumferential surface thereof when the filter rotates. Thus, the projection can remove dust from the filter. Further, the dust-dropping mechanism need not directly contact the filter element. For example, the mechanism may flip the filter frame supporting the filter element, thus vibrating the filter and ultimately removing dust from the filter. Since the mechanism does not frequency contact the filter element in this case, the filter element can be protected from damages.

Instead of one projection, a plurality of projections may be arranged at intervals in the circumferential direction of the filter. The filter can be oriented in any direction.

The dust-dropping mechanism may not vibrate the filter to drop the dust from the filter. Instead, it may apply air and may do anything else, to drop the dust from the filter.

Further, the filter may be shaped like a disc and have pleats extending in radial direction. Moreover, the filter is not limited to a pleat filter. Further, the filter may be fixed in place. In this case, the projection for dropping dust is rotated in the circumferential direction of the filter. If the projection is not rotated, and the filter is rotated instead, the device for rotating the filter may be removed from the separator case and attached to the main unit of the cleaner.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A vacuum cleaner comprising:
a separator case which has a dust-discharging port;
a motor-driven blower which generates a negative pressure in the separator case;
a separator which is provided in the separator case and has a separating chamber communicating with the dust-discharging port and configured to separate dust from air drawn into the separator case, by using an inertial force;
a dust-collecting section which collects the dust separated by the separator;
a filter which catches the dust passed through the separator;
a dust-dropping mechanism which drops the dust caught by the filter; and
a shield member which is configured to move between a first position and a second position, to connect the dust-discharging port to the separating chamber while remaining at the first position, and to disconnect the dust-discharging port from the separating chamber while remaining at the second position, said shield member remaining at the second position as long as the motor-driven blower operates, and moving to the first position to allow the dust dropped by the dust-dropping mechanism to move into the separating chamber through the dust-discharging port.

2. The vacuum cleaner according to claim 1, wherein the separator has a dust-recovering section extending at one end from the separating chamber and connected at the other end to the separating chamber, and the dust-discharging port opens to the dust-recovering section.

3. The vacuum cleaner according to claim 2, wherein the dust dropped from the filter by the dust-dropping mechanism is guided into the dust-recovering section from the dust-discharging port when the shield member moves to the first position, and the dust guided into the dust-recovering section is returned to the separating chamber by air flow from the separating chamber returning to the separating chamber through the dust-recovering section.

4. The vacuum cleaner according to claim 1, wherein the separator case has a bottom wall which receives the dust dropped from the filter and which inclines down toward the dust-discharging port.

5. The vacuum cleaner according to claim 4, wherein the dust-dropping mechanism vibrates the filter, thereby dropping the dust from the filter, and vibration of the dust-dropping mechanism is transmitted to the bottom wall of the separator case so that the dust on the bottom wall moves toward the dust-discharging port.

6. The vacuum cleaner according to claim 1, wherein the shield member is held at the second position by the negative pressure generated in the separator case.

7. A vacuum cleaner comprising:
a motor-driven blower which has an air-inlet port for generating a negative pressure;
a separator case which is connected to the air-inlet port of the motor-driven blower and which has a dust-discharging port;
a separator which is provided in the separator case and which includes a separating chamber in which dust is separated, by using an inertial force, from air drawn into the separator case by the motor-driven blower, and a dust-recovering section into which a part of the air flowing in the separating chamber flows and to which the dust-discharging port opens;
a dust-collecting section which collects the dust separated by the separator;
a filter which is supported by the separator, which is located downstream of the separator with respect to a direction in which the air flows, and which catches the dust passed through the separator;
a dust-dropping mechanism which drops the dust caught by the filter; and
a shield member which is configured to move between a first position and a second position, which opens the dust-discharging port while remaining at the first position, and which closes the dust-discharging port while remaining at the second position, said shield member remaining at the second position as long as the motor-driven blower operates, and moving to the first position to allow the dust dropped by the dust-dropping mechanism to move into the dust-recovering section through the dust-discharging port.

8. The vacuum cleaner according to claim 7, wherein the separator case has a bottom wall which receives the dust dropped from the filter and which inclines down toward the dust-discharging port.

9. The vacuum cleaner according to claim 8, wherein the dust-dropping mechanism vibrates the filter, thereby dropping the dust from the filter, and vibration of the dust-dropping mechanism is transmitted to the bottom wall of the separator case so that the dust on the bottom wall moves toward the dust-discharging port.

10. The vacuum cleaner according to claim 7, wherein the dust-recovering section has an air-inlet port through which a part of the air flowing in the separating chamber is drawn, and an air-outlet port through which the air is returns to the separating chamber and which is located downstream of the air-inlet port with respect to a direction in which the air flows in the separating chamber.
